(19) United States
(12) Patent Application Publication
(10) Pub. No.: US 2006/0073824 A1
(43) Pub. Date: Apr. 6, 2006

(54) System and method to avoid congestion in wireless networks

(75) Inventors: Murali Ranganathan, Chandler, AZ (US); John M. Harris, Chicago, IL (US); Suzanne S. Heflin, Elmhurst, IL (US)

Correspondence Address: MOTOROLA, INC., LAW DEPARTMENT, 1303 E. ALGONQUIN ROAD, SCHAUMBURG, IL, 60196, US

(73) Assignee: Motorola, Inc.

(21) Appl. No.: 10/953,333

(22) Filed: Sep. 29, 2004

(51) Int. Cl. H04Q 7/20

(52) U.S. Cl. 455/426.1

(57) ABSTRACT

A system and method to facilitate transmitting a data message between a base station (108) and a mobile station (122) determines whether the base station (108) is compliant in operation with the mobile station (122). Based upon the determining whether the base station (108) is compliant with the mobile station (122), a service scheme is selected to process a data message (200) sent from the base station (108) to the mobile station (122), and the data message (200) is processed using the service scheme.

### FIELD OF THE INVENTION

The field of the invention relates generally to wireless networks. More specifically, it relates to congestion control within these networks.

### BACKGROUND OF THE INVENTION

Many types of telecommunication systems exist and these systems employ various types of channels to allow the base stations to communicate with the mobile stations. One type of channel in common use today is a paging channel, where a base station sends messages to mobile stations that may be monitoring the paging channel in different cells or sectors.

In many paging systems, a particular messaging sequence is exchanged between the base station and the mobile units to convey system information or mobile specific information. In one example of a messaging sequence used within a paging system, Short Message Signal (SMS) pages are sent from a base station to a mobile station. Since the mobile station may be monitoring the paging channel in any cell or sector, the SMS page has to be sent to all the sectors/cells in a defined paging area. This is wasteful since the mobile is only present in one cell or sector. Techniques to locate a mobile station first before sending the SMS message have had limited success since these techniques require all mobile stations to be compliant with the scheme. Additionally, these existing schemes do not consider how loaded or unloaded the system is.

In current systems, problems occur because incompatible mobile stations are often operated within the same network. For example, as new techniques of processing messages are developed, older mobile units are inoperable or operate inefficiently with newer mobile stations because these older units can not respond to or use newer, more efficient, or different processing techniques. Consequently, congestion within the system increases and messages are lost. The lost messages result in further delays in transmitting information and cause significant end-user dissatisfaction.

### BRIEF DESCRIPTION OF THE DRAWINGS

FIG. 1 is a block diagram showing a system for reducing network congestion according to various embodiments of the present invention;

FIG. 2 is a block diagram showing a format for messages transmitted between mobile stations according to various embodiments of the present invention;

FIG. 3 is a flow chart of an approach for reducing congestion in a network according to various embodiments of the present invention;

FIG. 4 is a block diagram showing another system for reducing network congestion according to various embodiments of the present invention;

FIG. 5 is a flowchart of an approach for reducing congestion in a network according to various embodiments of the present invention; and

FIG. 6 is a flowchart of another approach for reducing congestion in a network according to various embodiments of the present invention;

Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are typically not depicted in order to facilitate a less obstructed view of these various embodiments of the present invention.

### DETAILED DESCRIPTION OF THE PREFERRED EMBODIMENTS

A system and method for reducing congestion in a network uses the determined compatibility of mobile units to select an appropriate service method for processing messages. In another approach, a discard rate is also sensed, and this is used along with the compatibility determination to select a service method.

In many of these embodiments, an approach for locating mobile stations of known or unknown compliance is provided while using the correct processing scheme based upon whether the network is in a loaded or unloaded state. For instance, when an SMS message is received at the base station, a mobile station is located by sending a compact SMS page message and the mobile station responding with an SMS page response.

In many of these embodiments, a data message is transmitted between a base station and a mobile station. A determination is made as to whether the base station is compliant in operation with the mobile station. Based upon whether the base station is compliant with the mobile station, a service scheme is selected to process a data message sent from the base station to the mobile station. The data message is processed using the selected service scheme.

In one example of how a message is processed, an identifier field in the data message is changed to a new value when it is determined that the mobile station is incompatible with the base station. Then, the data message is processed using a legacy service scheme. In another example, the processing uses a new or updated processing scheme after a determination has been made that the two units are compatible. An identifier field contained in the data message is not altered in this case.

In other embodiments, a discard rate is determined at a point in the wireless network. The discard rate determined at the point in the wireless network is compared to a predetermined threshold. A service scheme is then selected based upon comparing the determined rate to the threshold. A paging message is formed and the service scheme is applied to the paging message.

Thus, the compatibility of two mobile units and other factors are used to determine a service scheme to process a message. Newer, compatible units can have messages processed using more efficient techniques. On the other hand, the system supports older units that may not be compatible with existing messages. By supporting a range of types of mobile stations in an efficient manner, delays and congestion are reduced. As a result, the experience of a user operating in the system is enhanced.

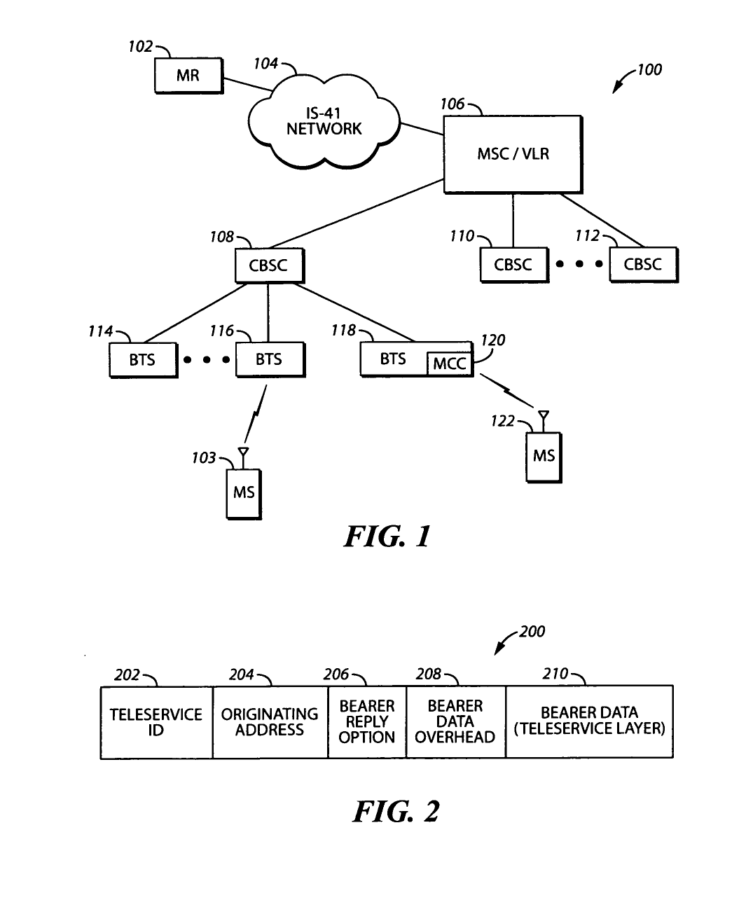

Referring now to FIG. 1, an example of a system for reducing congestion in a network is described. A message register (MR) framework 102 is coupled to an Interim Standard (IS)-41 network 104.

The MR framework 102 is a system that provides an interface to a variety of services such as voicemail services, Internet gateway services, instant messaging services, information services, and fax storage services. Other examples of services are possible. The MR framework 102 also integrates various types of messaging technologies such as Code Division Multiple Access (CDMA), Time Division Multiple Access (TDMA), Global System for Mobile Communications (GSM), and General Packet Radio Service (GPRS). In addition, the MR 102 provides a path from the Short Messaging Service (SMS) to other messaging services such as the Enhanced Messaging Service (EMS) and the Multimedia Messaging Service (MMS).

Messages and other types of communications are generated within the MR framework 102 and passed between the framework 102 and the IS-41 network 104. The MR framework 102 may include an SMS server that maintains a list of incompatible mobile stations. As described below, this information may be used to select a service type in order to process a message.

The IS-41 network 104 is a Wireless intelligent network (WIN) and conforms to the standards developed by the Telecommunications Industry Association (TIA) Standards Committee. Messages and data pass between different points within the network 104.

The IS-41 network 104 is coupled to the mobile switching center (MSC)/visitor location register (VLR) 106. The purpose of the MSC/VLR 106 is to provide an interface between the base station system and the switching subsystem of the mobile phone network. The MSC/VLR 106 is coupled to a plurality of centralized base station controllers (CBSCs) 108, 110, and 112 (“base stations”). The CBSCs 108, 110, and 112 provide connectivity between base transceiver stations (BTSs) and the MSC/VLR 106. In the example shown in FIG. 1, the CBSC 108 provides connectivity between the BTSs 114, 116, 118 and the MSC/VLR 106. The CBSCs 110 and 112 also provide connectivity between their corresponding BTSs (not shown) and the MSC/VLR 106.

Each of the BTSs 114, 116, and 118 include a MultiChannel Controller (MCC) 120. In this case, the MCC 120 is shown associated with the MTS 118. The MCC 120 connects the BTS 118 with mobile stations on the network 100. In one example, the MCC 120 connects the BTS 118 with the mobile station (MS) 122. The BTS 118 provides the control and transmission functionality needed to communicate with the MS 122. Messages are exchanged between the base station and a mobile station 123.

In one example of the operation of the system of FIG. 1, a message is sent between two points, for example, between two mobile stations in the network. A determination is first made as to whether the mobile stations are compatible in operation. For example, the MR 102 may maintain information that indicates the service type used at a particular mobile station.

The message to be sent is examined. This examination may occur at the MR framework 102, the MSC/VLR 106, or other points in the network. The examination looks at the teleservice ID field within the message. If the two mobile stations are not compliant, the ID may be changed to a temporary ID. On the other hand, if the two mobile stations are compliant in operation, then the ID remains unchanged. If the two mobile stations are not compliant, an older service method, for example, a legacy service method, may be used to process the message and the teleservice ID field is changed back to the original value. On the other hand, if the two mobile stations are compatible in operation, a newer or updated service method may be used to process the message.

In this way, messages between compliant mobiles are easily processed without creating problems in the transmission of messages between non-compliant mobiles. On the other hand, messages between non-compliant mobiles are also processed using an appropriate processing method. Since the service method is customized, loading and congestion is reduced significantly within the network. In addition, the loss of messages due to congestion within a network is significantly reduced.

Referring now to FIG. 2, an example of a message 200 passed between two mobiles is described. The message includes a teleservice ID field 202, originating address 204, bearer replay option 206, and bearer data 210. It will be understood that other types of message formats may be used and the format described with respect to FIG. 2 is only one example of many such formats.

The teleservice ID field 202 may be changed to a temporary value to indicate that two mobile units are not compatible. It may be of any length, however, in this example may be four bytes long.

The originating address 204 is the address of the sender of the SMS message. This field may be of any length. In this example it is five bytes long.

The bearer replay option 206 indicates how the receiving mobile unit should respond with an acknowledgement after it successfully receives the SMS message.

The bearer data overhead 208 describes the type of data that is sent in the bearer data field 210.

The bearer data 210 is the data to be transmitted. This field indicates information to be transmitted from a base station to a destination mobile station.

The message 200 is sent between base station and the destination mobile station. An examination of the message 200 is made of the teleservice ID field 202 within the message 200. If the mobile stations are not compliant in operation, the ID 202 may be changed to a temporary ID. On the other hand, if the base station and the mobile station are compliant in operation, then the ID field 202 remains unchanged. If the mobile stations are not compliant, an older service method, for example, a legacy service method, may be used to process the message and the teleservice ID field 202 is changed back to the original value. On the other hand, if the mobile stations are compatible in operation, a newer or updated method may be used to process the message.

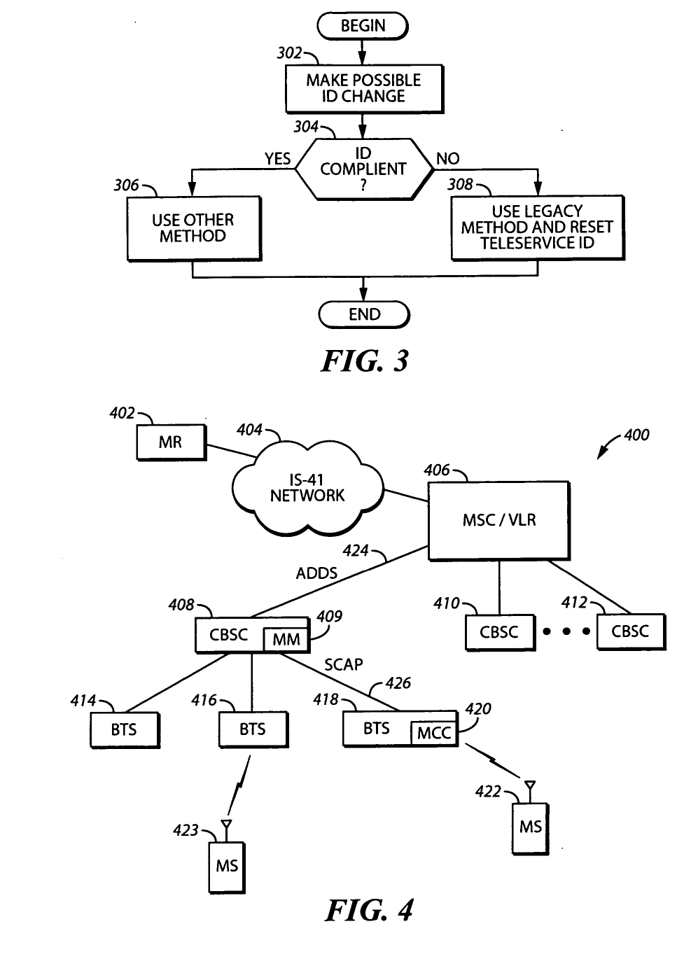

Referring now to FIG. 3, an example of processing a data message is described. At step 302, it is determined whether the ID field needs to be changed. With this step, the system examines and determines whether the two mobiles are compatible. If the mobiles stations are incompatible, a temporary ID is inserted into the teleservice field. If the two mobile stations are compatible, no change is made to the ID field.

At step 304, the message to be sent is examined. This examination may occur at the MR, the MSC, or other points in the network. The examination looks at the teleservice ID to see if the ID indicates compatible or incompatible mobiles.

If the two mobile stations are not compliant in operation, at step 308, a service method that is usable by a mobile station, for example, a legacy service method, may be used to process the message and the teleservice ID field is changed back to the original value. On the other hand, if the two mobile stations are compatible, at step 306, a newer method that is usable by both of the mobile stations may be used to process the message.

Referring now to FIG. 4, an example of another approach for reducing congestion in a network is described. A system 400 includes a message register (MR) framework 402, which is coupled to an Interim Standard (IS)-41 network 404.

The MR framework 402 is a framework that provides an interface to voicemail services, Internet gateway services, instant messaging services, information services, and fax storage services. Other examples of services are possible. The MR framework 402 also integrates various types of messaging technologies such as Code Division Multiple Access (CDMA), Time Division Multiple Access (TDMA), Global System for Mobile Communications (GSM), and General Packet Radio Service (GPRS). In addition, the MR 402 provides a path from the Short Messaging Service (SMS) to other messaging services such as the Enhanced Messaging Service (EMS) and the Multimedia Messaging Service (MMS).

Messages and other types of communications are generated within the MR framework 402 and passed between the framework 402 and the IS-41 network 404. The MR framework 102 may include an SMS server that maintains a list of incompatible mobile stations. As described below, this information may be used to select a service type in order to process a message.

The IS-41 network 404 is a Wireless intelligent network (WIN) and conforms to the standards developed by the Telecommunications Industry Association (TIA) Standards Committee. Messages and data pass between different points within the network 404.

The IS-41 network 404 is coupled to the mobile switching center (MSC)/visitor location register (VLR) 406. The purpose of the MSC/VLR 406 is to provide an interface between the base station system and the switching subsystem of the mobile phone network. The MSC/VLR 406 is coupled to a plurality of centralized base station controllers (CBSCs) 408, 410, and 412 (“base stations”). The CBCs 408, 410, and 412 provides connectivity between base transceiver stations (BTSs) and the MSC/VLR 406. In the example shown in FIG. 4, the CBSC 408 provides connectivity between the BTSs 414, 416, 418 and the MSC/VLR 406. The CBSCs 410 and 412 also provide connectivity between their corresponding BTSs (not shown) and the MSC/VLR 406. A mobility manager (MM) 409 tracks the discard rate of messages processed by the CBSC 408. Other MMs (not shown) are located at the CBSC 410 and the CBSC 412. The CBSCs and BTSs communication using a protocol 426, in this case, the SuperCell Application Protocol (SCAP). The MSC/VLR 406 communicates with the CBSCs using the ADDS message. The ADDS message is the vehicle used to carry the SMS message defined in the IOS standards specification.

Each of the BTSs 414, 416, and 418 includes a MultiChannel Controller (MCC) In this case, the MCC 420 is shown associated with the MTS 418. The MCC 420 connects the BTS 418 with mobile stations on the network 400. In one example, the MCC 420 connects the BTS 418 with the mobile station (MS) 422. The BTS 418 provides the control and transmission functionality needed to communicate with the MS 422. Messages are exchanged between the mobile station 422 and a mobile station 423.

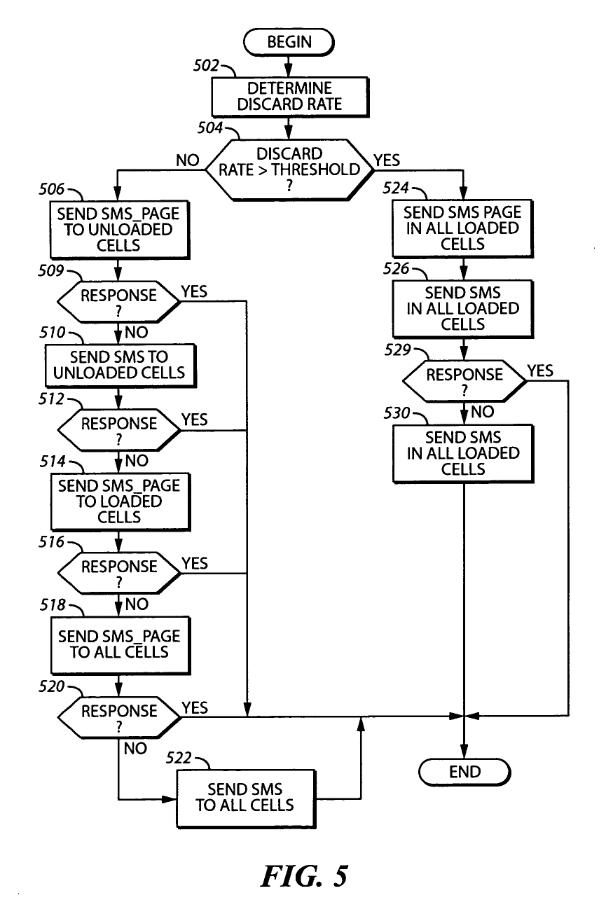

In one example of the operation of the network 400, the MM 409 tracks the discard rate of packets. If the discard rate is greater than a predetermined threshold, the system uses a certain service strategy to process a message. If the discard rate is less than the predetermined threshold, the system uses other service strategies to process the message. The strategies may include sending certain messages (e.g., SMS page messages) to certain types of cells (e.g., loaded or unloaded cells) within a network. An example of such an approach is described with respect to FIG. 5.

Referring now to FIG. 5, an example of a service strategy relating to the processing of an SMS_PAGE is described. It will be realized that other strategies can be developed to process SMS_PAGE messages and that other strategies may be used to service other types of messages.

At step 502, a discard rate of packets is determined. As described above, this may be done at the CBSCs within the system. At step 504, it is determined if the discard rate is greater than or equal to a threshold. If the answer is affirmative, control continues at step 524. If the answer is negative, execution continues at step 506.

At step 506, an SMS_PAGE is sent to unloaded cells. At step 508, it is determined if a response has been received to the SMS_PAGE sent at step 506. If the answer is affirmative, execution ends. If the answer is negative, control continues with step 510.

At step 510, an SMS message is sent to unloaded cells. At step 512, it is determined if a response has been received to the SMS message sent at step 510. If the answer is affirmative, execution ends. If the answer is negative, control continues with step 514.

At step 514, an SMS_PAGE is sent to loaded cells. At step 516, it is determined if a response has been received to the SMS_PAGE sent at step 514. If the answer is affirmative, execution ends. If the answer is negative, control continues with step 518.

At step 518, an SMS_PAGE is sent to all cells. At step 520, it is determined if a response has been received to the SMS_PAGE sent at step 518. If the answer is affirmative, execution ends. If the answer is negative, control continues with step 522. At step 522, an SMS message is sent to all cells. Execution then ends.

At step 524, an SMS_PAGE is sent to all loaded cells. At step 526, an SMS message is sent to all loaded cells. At step 528, it is determined if a response to the messages sent at steps 524 and/or 526 has been received. If the answer is affirmative, then execution ends. If the answer is negative, then at step 530 an SMS message is sent to all loaded cells. Execution then ends.

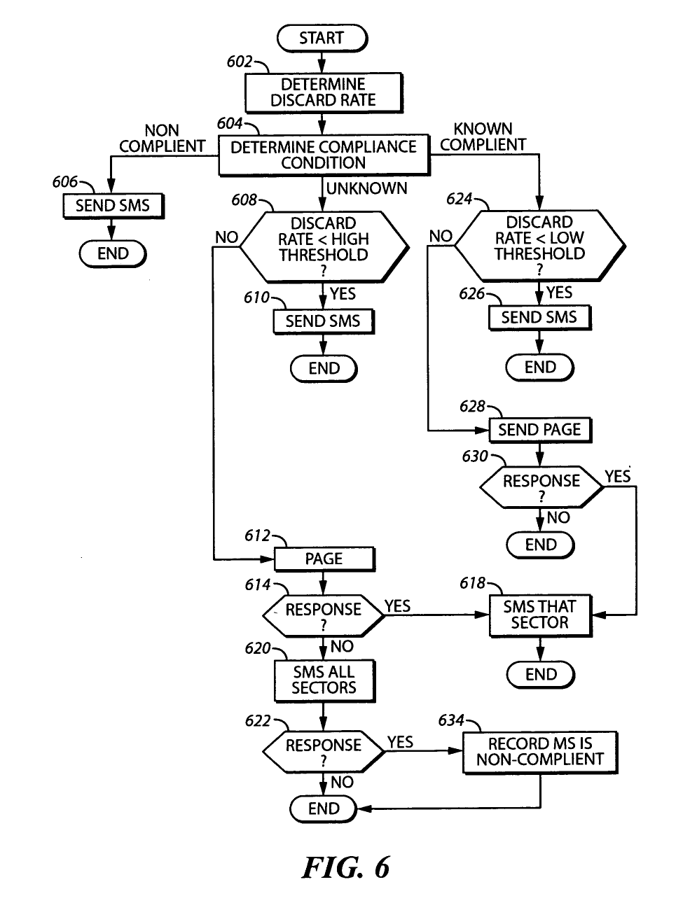

Referring now to FIG. 6, another approach for reducing congestion in a network is described. At step 602, a discard rate is determined. At step 604 a compliance condition is determined. This condition may indicate that a base station and mobile station are compliant, non-compliant, or that the compliance condition is unknown.

If the compliance condition is unknown, at step 606, an SMS message is sent. When the SMS message or paging message is sent, the system may optionally send these messages to the low loaded cells and then attempt sending these messages to higher loaded cells.

If the compliance condition is unknown, at step 608 a comparison is made to see if the discard rate is below a high threshold. The threshold is set higher to another threshold used in step 624 because an unknown compliance mobile may require traditional SMS delivery. If the answer is affirmative, at step 610, an SMS message is sent and execution ends. If the answer is negative, at step 612 a page is sent to a specific sector or cell. At step 614, it is determined if a response has been received to the page. If the answer is affirmative, at 618 an SMS message is sent to that sector or cell. If the answer is negative, at step 620, an SMS message is sent to all sectors or cells.

At step 622, it is determined if a response has been received. If the answer is affirmative, then at step 634, records in the system are changed to indicate non-compliance between the mobile station and the base station. Execution then ends. If the answer is negative, execution ends.

If the mobile station and the base station are compliant, then at step 624, it is determined if the discard rate is less than a low threshold. This threshold is lower than the threshold used at step 608 because for a known compliant mobile, traditional SMS delivery should be halted and a more efficient approach used. If the answer is affirmative, then at step 626 an SMS message is sent. Execution then ends. If the answer is negative, at step 628, a page is sent. At step 630 it is determined if a response to the page has been received. If the answer is negative, execution ends. If the answer is affirmative, the execution continues with step 618 as described above.

Thus, messages between mobiles are processed using a customized processing method. Since the service method is customized, loading and congestion is reduced significantly within the network. In addition, the loss of messages due to congestion within a network is significantly reduced.

While there have been illustrated and described particular embodiments of the present invention, it will be appreciated that numerous changes and modifications will occur to those skilled in the art, and it is intended in the appended claims to cover all those changes and modifications which fall within the true spirit and scope of the present invention.

What is claimed is:

1. A method to facilitate transmitting a data message between a base station and a mobile station comprising:
determining a compliance condition existing between a mobile station and a base station;
based upon the compliance condition between the mobile station and the base station, selecting a service scheme to process a data message sent from the base station to the mobile station, and processing the data message using the service scheme.

2. The method of claim 1 wherein determining a compliance condition comprises determining a condition selected from a group comprising compliant, non-compliant, or unknown.

3. The method of claim 1 wherein the processing comprises processing the data message using a legacy service scheme.

4. The method of claim 1 wherein the processing comprises changing an identifier field in the data message to a new value when the mobile station is incompatible with the base station and further comprising processing the data message using a legacy service scheme.

5. The method of claim 1 wherein the processing comprises maintaining and not altering an identifier field contained in the data message.

6. A method for reducing congestion in a wireless network comprising:
determining a discard rate at a point in the wireless network;
comparing the discard rate determined at the point in the wireless network to a predetermined threshold;
selecting a service scheme based upon the comparing;
forming a paging message; and
applying the service scheme to the paging message.

7. The method of claim 6 further comprising determining whether a mobile station is compliant in operation with a base station and wherein selecting the service scheme comprises selecting the service scheme based upon whether the mobile station is compliant in operation with the base station.

8. The method of claim 7 further comprising determining whether a wireless network cell is loaded.

9. The method of claim 8 wherein selecting a service scheme comprises selecting a service scheme based upon whether the mobile station is compliant in operation with the base station and whether the wireless network cell is loaded.

10. The method of claim 8 wherein selecting the service scheme comprises selecting a service scheme based upon whether the mobile station is compliant in operation with the base station and whether a network cell is loaded.

11. The method of claim 8 further comprising assuming the base station and the mobile station are compliant when a network cell is loaded and subsequently assuming the mobile station and the base station are noncompliant.

12. The method of claim 11 further comprising updating network records to reflect the mobile station is noncompliant.

13. The method of claim 8 further comprising assuming the base station and the mobile station are noncompliant when the network cell is unloaded.

14. The method of claim 6 wherein comparing the discard rate comprises comparing the discard rate to a high threshold when compliant and a lower threshold when noncompliant.

15. A device for reducing congestion in a paging network comprising:
a receiver for receiving a message on an input line; and
a controller coupled to the input line of the receiver, the controller receiving information via the input line and determining whether a mobile unit is operationally compatible with a base station, the controller programmed to determine a service scheme based upon contents of the message and process the message using the service scheme.

16. The device of claim 15 further comprising means for determining a discard rate, means for comparing the discard rate to a threshold to provide a comparison result, and means for selecting the service scheme based upon the comparison result.

17. The device of claim 16 further comprising means for using a legacy processing scheme when the base station and the mobile unit are not compatible.

18. The device of claim 15 further comprising means for changing an identifier to a temporary value when the base station and the mobile unit are not compatible.
